(19) United States
(12) Patent Application Publication
(10) Pub. No.: US 2006/0040184 A1
(43) Pub. Date: Feb. 23, 2006

(54) Non-aqueous electrolyte battery

(75) Inventor: Tomohito Okamoto, Kyoto (JP)

Correspondence Address: DARBY & DARBY P.C., P. O. BOX 5257, NEW YORK, NY, 10150-5257, US

(73) Assignees: Sanyo Electric Co., Ltd., Moriguchi-Shi (JP); Sanyo GS Soft Energy Co., Ltd., Kyoto-shi (JP)

(21) Appl. No.: 11/201,684

(22) Filed: Aug. 10, 2005

(30) Foreign Application Priority Data
Aug. 19, 2004 (JP) 2004-239328

(51) Int. Cl. H01M 10/40; H01M 4/58

(52) U.S. Cl. 429/306; 429/231.1; 429/231.8

(57) ABSTRACT

In the non-aqueous electrolyte battery comprising a positive electrode, a negative electrode and a polymer electrolyte layer, the theoretical capacity per unit area of the opposed positive electrode and negative electrode was set to larger than or equal to 3.00 mAh/cm² and smaller than or equal to 3.20 mAh/cm², the polymer electrolyte layer was formed as a porous layer including inorganic solid filler and the theoretical battery capacity was set to larger than or equal to 800 mAh and smaller than or equal to 4 Ah.

### CROSS-REFERENCE TO RELATED APPLICATIONS

This Nonprovisional application claims priority under 35 U.S.C. §119(a) on Patent Application No. 2004-239328 filed in Japan on Aug. 19, 2004, the entire contents of which are hereby incorporated by reference.

### BACKGROUND OF THE INVENTION

1. Field of the Invention

The present invention relates to a non-aqueous electrolyte battery comprising a positive electrode, a negative electrode and a polymer electrolyte layer.

2. Description of Related Art

In a polymer electrolyte battery having a polymer electrolyte layer between a positive electrode and a negative electrode (see Japanese Patent Application Laid-Open No. 2003-109663, for example), liquid leakage hardly occurs since the polymer layer has an action of retaining electrolytic solution. Moreover, since the polymer layer has an action of bonding an electrode and a separator, shrinkage of the separator is restrained in an abnormal state such as heating or overcharge and, therefore, short circuit of the electrode or the like hardly occurs and high security is provided.

In this regard, since a polymer layer is provided between electrodes, the ionic conductivity is low, the polarization tends to be increased and, especially, the low-temperature electrical discharge performance tends to lower in comparison with a battery which does not include a polymer layer. As a measure against this, for example, the amount of active material to be applied to a collector is decreased to decrease the theoretical capacity per unit area of the opposed positive electrode and negative electrode and to lower the current density, thereby restraining polarization.

With the above measure, however, the current to flow in short circuit tends to be increased and the generated Joule heat increases the possibility of occurrence of a problem such as heat generation or smoking due to the rise in temperature inside the battery. Especially, a polymer electrolyte battery using a case made of a laminate film as a covering member has a thermal conductivity of the covering member lower than that of a battery using a metal can such as aluminum as a covering member and heat generated from inside of the battery is hardly released through the covering member and, therefore, there is a problem that the temperature inside the battery tends more to rise, causing thermal runaway. Especially, when the battery capacity is large, the above problem tends more to occur since the current to flow in short circuit is increased.

### BRIEF SUMMARY OF THE INVENTION

The present invention has been made with the aim of solving the above problems, and it is an object thereof to provide a non-aqueous electrolyte battery capable of preventing heat generation or smoking due to temperature rise inside the battery in short circuit, by making the theoretical capacity per unit area of the opposed positive electrode and negative electrode larger than or equal to 3.00 mAh/cm² and smaller than or equal to 3.20 mAh/cm².

Another object of the present invention is to provide a non-aqueous electrolyte battery capable of restraining lowering of the low-temperature electrical discharge performance, by using a porous layer including inorganic solid filler as the polymer electrolyte layer.

Another object of the present invention is to provide a non-aqueous electrolyte battery capable of restraining lowering of the low-temperature electrical discharge performance while ensuring safety, by making the theoretical battery capacity larger than or equal to 800 mAh and smaller than or equal to 4 Ah.

A non-aqueous electrolyte battery according to the first aspect is a non-aqueous electrolyte battery comprising a positive electrode, a negative electrode and a polymer electrolyte layer, characterized in that a theoretical capacity per unit area of the opposed positive electrode and negative electrode is larger than or equal to 3.00 mAh/cm² and smaller than or equal to 3.20 mAh/cm².

A non-aqueous electrolyte battery according to the second aspect is based on the first aspect, and characterized in that the polymer electrolyte layer is a porous layer including inorganic solid filler.

A non-aqueous electrolyte battery according to the third aspect is based on the first or second aspect, and characterized in that a theoretical battery capacity is larger than or equal to 800 mAh and smaller than or equal to 4 Ah.

In the first aspect, since the theoretical capacity per unit area of the opposed positive electrode and negative electrode is increased to larger than or equal to 3.00 mAh/cm², it is possible to decrease the current to flow in short circuit by the increase of the active material layer and to prevent heat generation or smoking due to temperature rise inside the battery in short circuit. In this regard, since the low-temperature electrical discharge performance tends to lower when the theoretical capacity per unit area is increased, the theoretical capacity per unit area is set to be smaller than or equal to 3.20 mAh/cm² thereby minimalizing lowering of the low-temperature electrical discharge performance.

In the second aspect, since the porous layer including inorganic solid filler has superior ionic conductivity, it is possible to restrain lowering of the low-temperature electrical discharge performance by using the porous layer including inorganic solid filler as the polymer electrolyte layer, even though the low-temperature electrical discharge performance tends to lower when the theoretical capacity per unit area is increased as described above.

In the third aspect, since the Joule heat in electrical discharge is much and the battery temperature tends to rise in a battery having a theoretical battery capacity larger than or equal to 800 mAh, the electrical discharge performance tends more to rise even at a low temperature. In this regard, since the short-circuit current tends to be increased in a battery having a theoretical battery capacity as large as larger than or equal to 4 Ah even when a capacity per unit area is increased, thermal runaway tends more to occur. It is therefore possible with a battery having a battery capacity larger than or equal to 800 mAh and smaller than or equal to 4 Ah to restrain lowering of the low-temperature electrical discharge performance while ensuring safety.

With the first aspect, it is possible to prevent heat generation or smoking due to temperature rise inside the battery in short circuit.

With the second aspect, it is possible to restrain lowering of the low-temperature electrical discharge performance.

With the third aspect, it is possible to restrain lowering of the low-temperature electrical discharge performance while ensuring safety.

The above and further objects and features of the invention will more fully be apparent from the following detailed description with accompanying drawings.

### BRIEF DESCRIPTION OF THE SEVERAL VIEWS OF THE DRAWINGS

FIG. 1 is an exploded perspective view of a polymer electrolyte battery according to the present invention;

FIG. 2 is a table showing the outline of batteries of the respective examples and the respective comparative examples; and

FIG. 3 is a table showing the test result of the respective examples and the respective comparative examples.

### DETAILED DESCRIPTION OF THE INVENTION

The following description will explain the present invention in the concrete with reference to the drawings illustrating some embodiments thereof.

### EXAMPLE 1

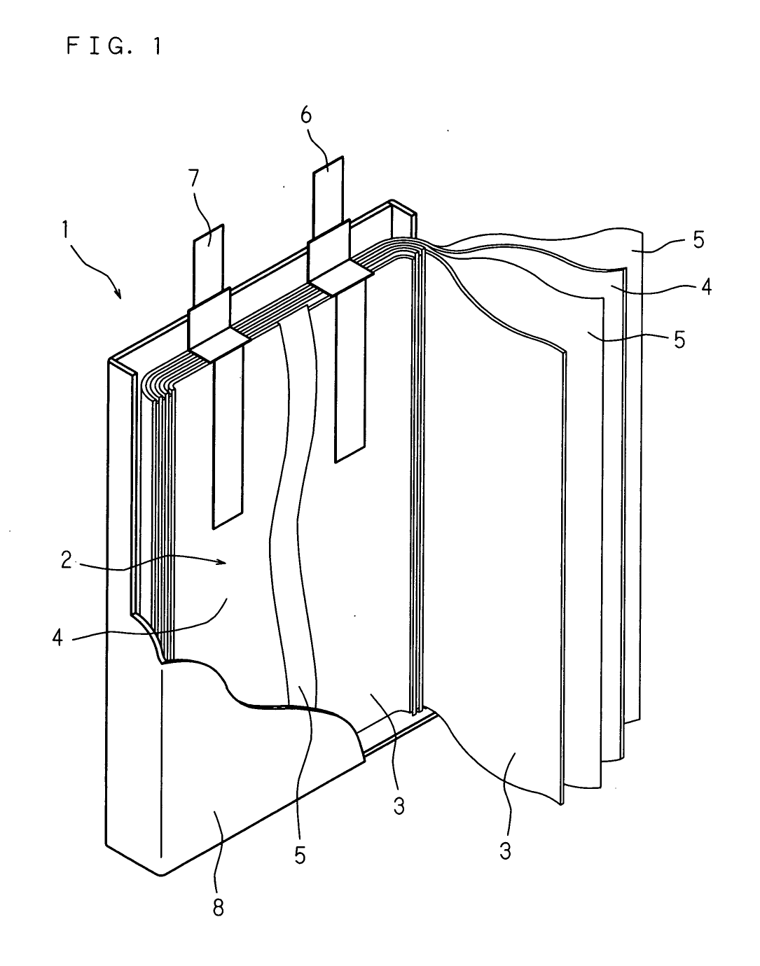

FIG. 1 is an exploded perspective view of a polymer electrolyte battery (non-aqueous electrolyte battery) according to the present invention. In FIG. 1, denoted at 1 is a polymer electrolyte battery (which will be hereinafter referred to as a battery), denoted at 2 is a generating element, denoted at 3 is a positive electrode, denoted at 4 is a negative electrode, denoted at 5 is a separator, denoted at 6 is a positive electrode terminal, denoted at 7 is a negative electrode terminal and denoted at 8 is a battery case. The generating element 2 is made by winding the positive electrode 3 and the negative electrode 4 via the separator 5 and has a polymer electrolyte layer between the positive electrode 3 and the negative electrode 4. Moreover, the positive electrode 3 is connected with the positive electrode terminal 6 while the negative electrode 4 is connected with the negative electrode terminal 7.

Regarding the positive electrode 3, lithium composite metal compound LiCoO₂ of 94% by mass as positive active material, acetylene black of 3% by mass as conductive agent and polyvinylidene fluoride (PVDF) of 3% by mass as binding agent were mixed to make positive depolarizing mix for cell, which was then dispersed into N-methyl-2-pyrrolidone (NMP) to prepare positive slurry. This positive slurry was applied evenly to both sides of an aluminum foil collector having a thickness of 15 μm to form a layer of the positive depolarizing mix for cell and after drying the layer of the positive depolarizing mix for cell layer, compression molding was performed by a roller press to prepare the positive electrode 3.

Regarding the negative electrode 4, NMP was added to and mixed with graphite powder of 95% by mass as active material and PVDF of 5% by mass as binding agent to prepare negative slurry. This negative slurry was applied evenly to both sides of a copper foil collector having a thickness of 10 μm, and was dried, and then compression molding was performed by a roller press to prepare the negative electrode 4.

Used for the separator 5 was a microporous polyethylene film having a thickness of 16 μm. One obtained by dissolving plasticizer such as dimethyl carbonate in polymer such as PVDF was applied to this separator 5 and then the positive electrode 3 and the negative electrode 4 were wound via the separator 5 to prepare the generating element 2. This generating element 2 was dried in a vacuum at 100° C. for 12 hours to remove the plasticizer, so that the polymer solidifies to form a polymer layer (polymer electrolyte layer) and the separator 5 was bonded with the positive electrode 3 or the negative electrode 4. The generating element 2 dried in a vacuum was packed in the battery case 8 made of an aluminum laminated film having a thickness of 90 μm, then electrolytic solution obtained by dissolving LiPF₆ of 1 mol in mixture solvent of ethylene carbonate and diethyl carbonate (volume ratio of 1:2) was injected and the battery case 8 was sealed by thermal welding or the like, so that the battery 1 was prepared.

The charging voltage of the battery 1 is 4.2 V. In this charging voltage, the positive active material is LiCoO₂ in a state of discharge while lithium of 58% desorbs in a state of full charge. Therefore, the initial charging capacity per unit mass is 159 mAh/g, which corresponds to 58% of the theoretical capacity per unit mass of LiCoO₂ of 273.8 mAh/g. Moreover, the positive electrode 3 has a layer of a positive depolarizing mix for cell, which has a mass per unit area of a single side (which will be hereinafter referred to as a single side unit area mass) in a dried manner of 0.0215 g/cm², a width of 5.2 cm and a length of 24.1 cm (including active material of 94% by mass), on both sides of the aluminum foil collector, and the positive electrode terminal 6 is welded at a winding innermost circumference portion which includes only the aluminum foil collector and not the layer of the positive depolarizing mix for cell. Accordingly, the initial charging capacity of the positive electrode 3 is 805 (=159×0.0215×5.2×24.1×2×0.94) mAh.

Moreover, in the negative electrode 4, the initial irreversible amount of the graphite powder used in this explanation is 21 mAh/g. Moreover, the negative electrode 4 has a layer of a negative depolarizing mix for cell, which has a mass per unit area of a single side (which will be hereinafter referred to as a single side unit area mass) in a dried manner of 0.0107 g/cm² and a width of 5.3 cm and is cut out to exist only at a portion (having a length of 24.1 cm) opposed to the layer of the positive depolarizing mix for cell (including active material of 95% by mass), on both sides of the copper foil collector, and the negative electrode terminal 7 is welded at a winding innermost circumference portion which includes only the copper foil collector and not the layer of the negative depolarizing mix for cell. Accordingly, the irreversible amount of the negative electrode 4 is 55 (=21×0.0107×5.3×24.1×2×0.95) mAh.

As is clear from the above description, the theoretical capacity per unit area (which will be hereinafter referred to as unit area capacity) of the opposed positive electrode 3 and negative electrode 4 is 3.00 (=159×0.0215×0.94−21×0.0107×0.95) mAh/cm² and the theoretical battery capacity (which will be hereinafter referred to as battery capacity) is 750 (=805-55) mAh. It should be noted that the theoretical capacity per unit area of the graphite powder, which is negative active material, is 372 mAh/g and the ratio between the theoretical capacity of the positive electrode and the theoretical capacity of the negative electrode per unit area is set to 0.68 (=(372×0.0107×0.95)/(273.8×0.0215×0.94)).

### EXAMPLE 2

A battery was prepared, which was the same as the Example 1 except that the length of the layer of the depolarizing mix for cell was set to 25.7 cm and the battery capacity was 800 mAh.

### EXAMPLE 3

A battery was prepared, which was the same as the Example 1 except that the length of the layer of the depolarizing mix for cell was set to 27.3 cm and the battery capacity was 850 mAh.

### EXAMPLE 4

A battery was prepared, which was the same as the Example 1 except that the length of the layer of the depolarizing mix for cell was set to 26.4 cm, the single side unit area mass of the layer of the positive depolarizing mix for cell was set to 0.0222 g/cm², the single side unit area mass of the layer of the negative depolarizing mix for cell was set to 0.0110 g/cm², the unit area capacity was 3.10 mAh/cm² and the battery capacity was 850 mAh.

### EXAMPLE 5

A battery was prepared, which was the same as the Example 1 except that the length of the layer of the depolarizing mix for cell was set to 25.6 cm, the single side unit area mass of the layer of the positive depolarizing mix for cell was set to 0.0229 g/cm², the single side unit area mass of the layer of the negative depolarizing mix for cell was set to 0.0114 g/Cm², the unit area capacity was 3.20 mAh/cm² and the battery capacity was 850 mAh.

### EXAMPLE 6

A battery was prepared, which was the same as the Example 1 except that the length of the layer of the depolarizing mix for cell was set to 37.3 cm, the single side unit area mass of the layer of the positive depolarizing mix for cell was set to 0.0222 g/cm², the single side unit area mass of the layer of the negative depolarizing mix for cell was set to 0.0110 g/cm², the unit area capacity was 3.10 mAh/cm² and the battery capacity was 1200 mAh.

### EXAMPLE 7

A battery was prepared, which was the same as the Example 1 except that the length of the layer of the depolarizing mix for cell was set to 74.5 cm, the single side unit area mass of the layer of the positive depolarizing mix for cell was set to 0.0222 g/cm², the single side unit area mass of the layer of the negative depolarizing mix for cell was set to 0.0110 g/cm², the unit area capacity was 3.10 mAh/cm² and the battery capacity was 2400 mAh.

### EXAMPLE 8

A battery was prepared, which was the same as the Example 1 except that the length of the layer of the depolarizing mix for cell was set to 99.4 cm, the single side unit area mass of the layer of the positive depolarizing mix for cell was set to 0.0222 g/cm², the single side unit area mass of the layer of the negative depolarizing mix for cell was set to 0.0110 g/cm², the unit area capacity was 3.10 mAh/Cm² and the battery capacity was 3200 mAh.

### EXAMPLE 9

A battery was prepared, which was the same as the Example 1 except that the length of the layer of the depolarizing mix for cell was set to 124.2 cm, the single side unit area mass of the layer of the positive depolarizing mix for cell was set to 0.0222 g/cm², the single side unit area mass of the layer of the negative depolarizing mix for cell was set to 0.0110 g/cm², the unit area capacity was 3.10 mAh/cm² and the battery capacity was 4000 mAh.

### EXAMPLE 10

A battery was prepared, which was the same as the Example 1 except that the length of the layer of the depolarizing mix for cell was set to 149.1 cm, the single side unit area mass of the layer of the positive depolarizing mix for cell was set to 0.0222 g/cm², the single side unit area mass of the layer of the negative depolarizing mix for cell was set to 0.0110 g/cm², the unit area capacity was 3.10 mAh/cm² and the battery capacity was 4800 mAh.

### EXAMPLE 11

A battery was prepared, which was the same as the Example 1 except that the polymer electrolyte layer was formed as a porous layer of inorganic solid filler (PVDF and Al₂O₃), the length of the layer of the depolarizing mix for cell was set to 37.3 cm, the single side unit area mass of the layer of the positive depolarizing mix for cell was set to 0.0222 g/cm², the single side unit area mass of the layer of the negative depolarizing mix for cell was set to 0.0110 g/cm², the unit area capacity was 3.10 mAh/cm² and the battery capacity was 1200 mAh.

### EXAMPLE 12

A battery was prepared, which was the same as the Example 1 except that the polymer electrolyte layer was formed as a porous layer of inorganic solid filler (PVDF and TiO₂), the length of the layer of the depolarizing mix for cell was set to 37.3 cm, the single side unit area mass of the layer of the positive depolarizing mix for cell was set to 0.0222 g/cm², the single side unit area mass of the layer of the negative depolarizing mix for cell was set to 0.0110 g/cm², the unit area capacity was 3.10 mAh/cm² and the battery capacity was 1200 mAh.

### COMPARATIVE EXAMPLE 1

A battery was prepared, which was the same as the Example 1 except that the length of the layer of the depolarizing mix for cell was set to 28.2 cm, the single side unit area mass of the layer of the positive depolarizing mix for cell was set to 0.0208 g/cm², the single side unit area mass of the layer of the negative depolarizing mix for cell was set to 0.0103 g/cm², the unit area capacity was 2.90 mAh/cm² and the battery capacity was 850 mAh.

### COMPARATIVE EXAMPLE 2

A battery was prepared, which was the same as the Example 1 except that the length of the layer of the depolarizing mix for cell was set to 39.8 cm, the single side unit area mass of the layer of the positive depolarizing mix for cell was set to 0.0208 g/cm², the single side unit area mass of the layer of the negative depolarizing mix for cell was set to 0.0103 g/cm², the unit area capacity was 2.90 mAh/cm² and the battery capacity was 1200 mAh.

### COMPARATIVE EXAMPLE 3

A battery was prepared, which was the same as the Example 1 except that the length of the layer of the depolarizing mix for cell was set to 24.8 cm, the single side unit area mass of the layer of the positive depolarizing mix for cell was set to 0.0236 g/cm², the single side unit area mass of the layer of the negative depolarizing mix for cell was set to 0.0117 g/cm², the unit area capacity was 3.30 mAh/cm² and the battery capacity was 850 mAh.

### COMPARATIVE EXAMPLE 4

A battery was prepared, which was the same as the Example 1 except that the polymer electrolyte layer was formed as a porous layer of inorganic solid filler (PVDF and Al₂O₃), the length of the layer of the depolarizing mix for cell was set to 24.8 cm, the single side unit area mass of the layer of the positive depolarizing mix for cell was set to 0.0236 g/cm², the single side unit area mass of the layer of the negative depolarizing mix for cell was set to 0.0117 g/cm², the unit area capacity was 3.30 mAh/cm² and the battery capacity was 850 mAh.

### COMPARATIVE EXAMPLE 5

A battery was prepared, which was the same as the Example 1 except that the polymer electrolyte layer was formed as a porous layer of inorganic solid filler (PVDF and Al₂O₃), the length of the layer of the depolarizing mix for cell was set to 116.7 cm, the single side unit area mass of the layer of the positive depolarizing mix for cell was set to 0.0236 g/cm², the single side unit area mass of the layer of the negative depolarizing mix for cell was set to 0.0117 g/cm², the unit area capacity was 3.30 mAh/cm² and the battery capacity was 4000 mAh.

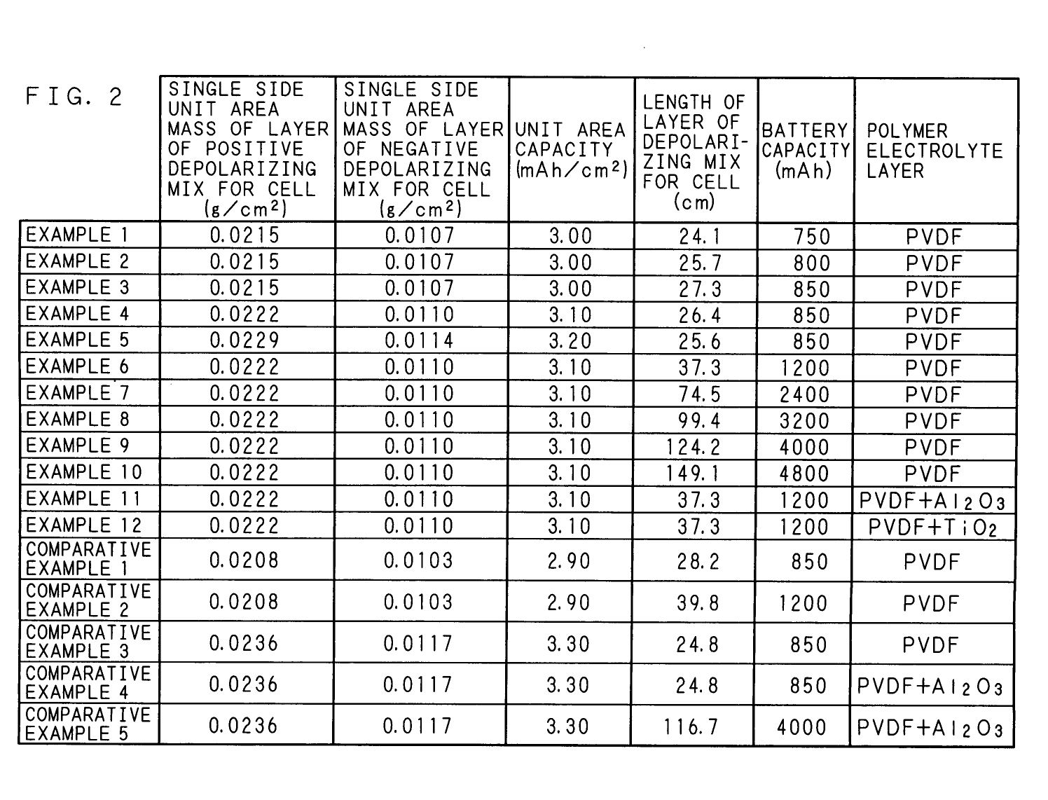

The outline of batteries of the respective examples and the respective comparative examples described above is shown in FIG. 2.

A nail piercing test and a low-temperature electrical discharge performance test were performed for batteries of the respective examples and the respective comparative examples. In the nail piercing test, each battery was charged to 4.2 V, then a nail made of steel having a diameter of 3 mm was struck so as to run through the battery case 8 and the existence of liquid leakage, smoking or the like was checked. Ten tests were performed for the respective examples and the respective comparative examples.

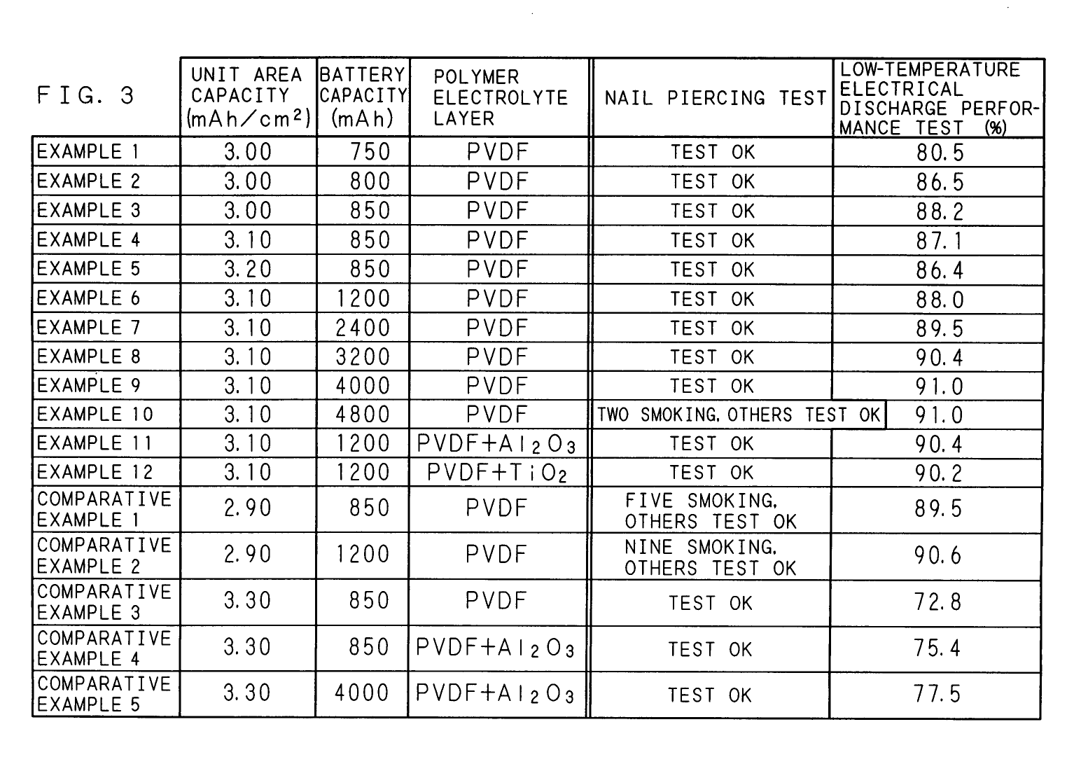

In the low-temperature electrical discharge performance test, each battery was charged to 4.2 V at 25° C. and then the capacity of a case of discharging at 1 CmA (current capable of discharging the battery capacity in one hour, which is 750 mA in the Example 1 and 800 mA in the Example 2, for example) at 25° C. was measured, and each battery was charged to 4.2 V at 25° C. next and then the capacity of a case of discharging at 1 CmA at 0° C. was measured, so as to obtain the low-temperature electrical discharge performance (=100×“discharge capacity at 0° C.”/“discharge capacity at 25° C.” [%]). Three tests were performed for the respective examples and the respective comparative examples, and the mean value of the three measured values was obtained. The test result is shown in FIG. 3.

The low-temperature electrical discharge performance is lower than 80% in a case where the unit area capacity is 3.30 mAh/cm² as shown by the Comparative Examples 3 to 5 in FIG. 3 while the low-temperature electrical discharge performance is higher than or equal to 80% in a case where the unit area capacity is smaller than or equal to 3.20 mAh/cm² as shown by the Examples 1 to 12 and the Comparative Examples 1 and 2 in FIG. 3. Moreover, smoking occurs in more than half of batteries in the nail piercing test in a case where the unit area capacity is 2.90 mAh/cm² as shown by the Comparative Examples 1 and 2 in FIG. 3. Accordingly, the unit area capacity (theoretical capacity per unit area) is preferably larger than or equal to 3.00 mAh/cm² and smaller than or equal to 3.20 mAh/cm².

Moreover, in the Examples 1 to 12 having a theoretical capacity per unit area larger than or equal to 3.00 mAh/cm² and smaller than or equal to 3.20 mAh/cm², the battery capacity (theoretical battery capacity) is preferably smaller than or equal to 4000 mAh since smoking occurs in a few batteries of the Example 10 having a battery capacity of 4800 mAh. Moreover, in the Examples 1 to 12, the battery capacity (theoretical battery capacity) is preferably larger than or equal to 800 mAh since the low-temperature electrical discharge performance of the Example 1 having a battery capacity of 750 mAh is as slightly small as 80.5%.

Furthermore, as shown by the Examples 6, 11 and 12 in FIG. 3, the Examples 11 and 12 using a porous layer including inorganic solid filler as the polymer electrolyte layer have enhanced low-temperature electrical discharge characteristics in comparison with the Example 6 which does not include inorganic solid filler.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A non-aqueous electrolyte battery comprising:
a positive electrode;
a negative electrode; and
a polymer electrolyte layer,
wherein a theoretical capacity per unit area of the opposed positive electrode and negative electrode is larger than or equal to 3.00 mAh/cm² and smaller than or equal to 3.20 mAh/cm².

2. The non-aqueous electrolyte battery according to claim 1, wherein the polymer electrolyte layer is a porous layer including inorganic solid filler.

3. The non-aqueous electrolyte battery according to claim 2, wherein a theoretical battery capacity is larger than or equal to 800 mAh and smaller than or equal to 4 Ah.

4. The non-aqueous electrolyte battery according to claim 2, wherein the inorganic solid filler includes Al₂O₃ or TiO₂.

5. The non-aqueous electrolyte battery according to claim 1, wherein a theoretical battery capacity is larger than or equal to 800 mAh and smaller than or equal to 4 Ah.

6. The non-aqueous electrolyte battery according to claim 1, wherein the positive electrode includes lithium composite metal oxide.

7. The non-aqueous electrolyte battery according to claim 1, wherein the negative electrode includes carbonaceous substance.
